(19) United States
(12) Patent Application Publication
(10) Pub. No.: US 2004/0256015 A1
(43) Pub. Date: Dec. 23, 2004

(54) Drinking straw

(76) Inventor: Desmond Margetson, New York, NY (US)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/876,999

(22) Filed: Jun. 25, 2004

Related U.S. Application Data
(63) Continuation-in-part of application No. 10/786,433, filed on Feb. 27, 2004.
(60) Provisional application No. 60/455,600, filed on Mar. 19, 2003.

(51) Int. Cl. F16L 9/00

(52) U.S. Cl. 138/109

(57) ABSTRACT

An elongated straw provided with a plurality of perforations at one end thereof to act as a means for consuming juice from citrus fruit or filter against any particles in a liquid to be consumed when the inserted end is pressed vertically on the base of the drinking vessel to shut off influx from the open, inside diameter, inserted end, while allowing flow through the perforations and a method of consuming a liquid using the same.

### PRIOR APPLICATION

This application is a Continuation-in-Part of U.S. patent application Ser. No. 10/786,433 filed Feb. 27, 2004 which is a non-provisional application based on provisional patent Application Ser. No. 60/455,600 filed Mar. 19, 2003.

### STATE OF THE ART

Metal drinking straws made of stainless steel, for example, have been produced and sold since 1999 under the trademark STYLO 2000. However, use thereof for drinking loose tea results in the large tea particles clogging and being ingested through the straw.

### OBJECTS OF THE INVENTION

It is an object of the invention to provide improved straws to provide straining out of large particles and to avoid clogging in use.

This and other objects and advantages of the invention will be obvious from the following detailed description.

### THE INVENTION

The novel straw of the invention is an elongated metal or plastic straw provided at one end thereof with a plurality of transverse holes. When in use, the straw is inserted vertically into the liquid to be consumed and in contact with the base of the container holding the liquid and then suction is applied to the straw to allow the liquid to be passed through the straw strainer holes while tea leaves, yerba mate or any other particles are strained out of the liquid. This enables one to use the straw without intake from the inserted end of large particles.

It can be used for drinking juice directly from citrus fruit such as oranges, grapefruit and lemons but care must be taken to insert tube into skin on an angle, precluding the clogging of the straw.

### REFERRING TO THE DRAWINGS

FIG. 1 illustrates a straw of the invention.

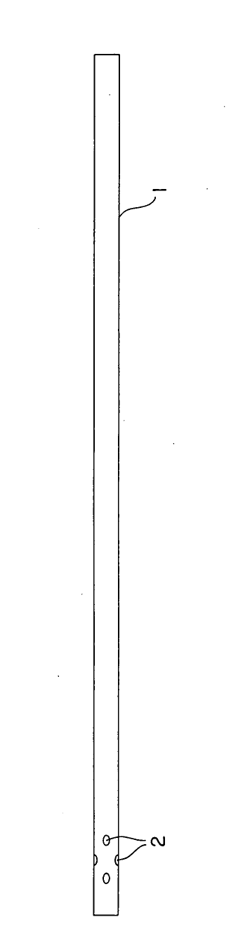

In FIG. 1, a metal or plastic straw (1) is shown in the transverse direction with a plurality of small holes (2) at one end thereof which will act as a filter so the liquid may be withdrawn by the straw while leaving behind any particles in the liquid such as tea leaves when the inserted end is shut off by vertical contact with the base of the vessel.

The straw may be made of any suitable metal or plastic or paper or any suitable material stiff enough to allow drilling of the perforations and the holes one of a suitable diameter to allow passage of the liquid into the straw while filtering out any particles therein. A suitable diameter would be 0.25 mm but could be smaller or larger depending upon the liquid to be consumed and the size of the particles therein. A typical straw is preferably about 8 inches long with a quarter inch diameter and a wall thickness of 0.025 inches but the dimensions are variable. The number of holes would be variable. A through transverse drilled hole would provide a two-strainer hole straw. The straw may also be colored.

Various modifications of the straw may be made without departing from the spirit or scope of the invention and it is to be understood that the invention is intended to be limited only as defined in the appended claims.

1. An elongated straw provided with a plurality of perforations at one end thereof to act as a means for consuming juice from citrus fruit or filter against any particles in a liquid to be consumed when the inserted end is pressed vertically on the base of the drinking vessel to shut off influx from the open, inside diameter, inserted end, while allowing flow through the perforations.

2. The straw of claim 1 wherein the straw is made of stainless steel.

3. The straw of claim 1 wherein the variable number of perforations have a diameter of approximately 0.25 mm at variable distances from the same end.

4. The straw of claim 1 wherein the straw is made of plastic.

5. A method of drinking juice directly from citrus fruit comprising inserting the straw of claim 1 into the fruit skin on an angle to preclude clogging of the straw by the skin and sucking the liquid through the straw strainer holes.

6. A method of consuming a liquid containing particles or residue in the container comprising inserting a straw of claim 1 into the liquid, vertically contacting the straw with the base of the container and sucking liquid free of particles through the straw, most particles, and leaves collect at the base of the container by gravity.
